(19) United States
(12) Patent Application Publication
(10) Pub. No.: US 2009/0217004 A1
(43) Pub. Date: Aug. 27, 2009

(54) CACHE WITH PREFETCH

(75) Inventors: Jan-Willem Van De Waerdt, San Jose, CA (US); Jean-Paul Vanitegem, San Jose, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: Koninkliijke Phillips Electronics N.V., Eindhoven (NL)

(21) Appl. No.: 11/719,399

(22) PCT Filed: Nov. 15, 2005
(86) PCT No.: PCT/IB2005/053767

§ 371 Date: May 11, 2009

Related U.S. Application Data
(60) Provisional application No. 60/627,870, filed on Nov. 15, 2004.

(51) Int. Cl. G06F 9/38; G06F 12/08

(52) U.S. Cl. 712/207; 711/137; 711/E12.057; 712/E09.055; 712/E09.047

(57) ABSTRACT

A prefetch bit (126) is associated with cache block (125) of a cache (120), and the management (130) of cache-prefetch operations is based on the state of this bit (126). Further efficiencies are gained by allowing each application to identify memory areas (115) within which regularly repeating memory accesses are likely, such as frame memory in a video application. For each of these memory areas (115), the application also identifies a likely stride value, such as the line length of the data in the frame memory. Pre-fetching is limited to the identified areas (115), and the prefetch bit (126) is used to identify blocks (125) from these areas and to limit repeated cache hit/miss determinations.

This invention relates to the field of processing systems, and in particular to a processor that includes a cache with prefetch capabilities.

The transfer of data between a processor and external memory often consumes a substantial amount of time, and techniques have been developed to reduce the impact of this data transfer. Two such techniques include the use of cache memory and the use of pre-fetching.

For ease of reference and understanding, the operation of a cache is defined hereinafter in terms of a “read” access, wherein the processor requests data from a memory address. One of ordinary skill in the art will recognize that the principles of this invention are applicable to “write” access operations as well.

Cache memory is located closer to the processor than the external memory, often within the same integrated circuit as the processor. When the processor requests a data item from a memory address, the cache is checked to determine whether the cache contains data corresponding to the memory address. A “cache-hit” occurs when the cache contents correspond to the memory address; otherwise a “cache-miss” occurs.

If a cache-hit occurs, the data transfer is effected between the cache and the processor, rather than between the memory and the processor. Because the cache is closer to the processor, the time required for a cache-processor transfer is substantially less than the time required for a memory-processor transfer.

If a cache-miss occurs, the data is transferred from the memory to the cache, and then to the processor. When the data is transferred from the memory, a “block” or “line” of data is transferred, on the assumption that future requests for data from the memory will exhibit spatial or temporal locality. Spatial locality corresponds to a request for data from an address that is close to a prior requested address. Temporal locality corresponds to requests for the same data within a short time of a prior request for the data. If spatial or temporal locality is prevalent in an application, the overhead associated with managing the data transfers via the cache is compensated by the savings achieved by multiple cache-processor transfers from the same block of cache.

Pre-fetching is used to reduce the impact of memory-cache or memory-processor transfers by attempting to predict future requests for data from memory. The predicted memory access is executed in parallel with operations at the processor, in an attempt to have the data from the predicted memory address available when the processor executes the predicted request. In a typical pre-fetch system, memory access operations at the processor are monitored to determine memory access trends. For example, do-loops within a program often step through data using a regular pattern, commonly termed a data-access “stride”. After the first few cycles through the loop, the pre-fetch system is likely to determine the stride, and accurately predict subsequent data requests. In a typical pre-fetch system, a table of determined stride values is maintained, indexed by the program address at which the repeating accesses occur. Whenever the program counter indicates that the program is again at an address of prior repeating accesses, the stride value from the table corresponding to the address is used to pre-fetch data from the memory. Other means of predicting future memory accesses are common in the art. Depending upon the particular embodiment, the predicted data is loaded into a pre-fetch buffer, or into the cache, for faster transfer to the processor than from the memory. By preloading the data into the cache, the likelihood of a cache-miss is reduced, if the prediction is correct.

Conventional cache-prefetch combinations require substantial overhead and/or exhibit inefficiencies. After the cache becomes full, each time a cache block is loaded into the cache, an existing cache block must be overwritten. If the block that is being overwritten has been used to write data intended for the memory, the existing block must be copied to memory before the new block overwrites this data. Thus, each wrong prediction has the potential of defeating the gains that might have been realized by having the overwritten block in the cache, as well as consuming unnecessary bus bandwidth and power for transferring data to the cache that is not used by the processor.

Generally, the accuracy of the predictions for pre-fetching is related to the amount of resources devoted to determining predictable memory access patterns. Therefore, to avoid the loss of potential cache-efficiency gains cause by erroneous predictions, a significant amount of prediction logic is typically required, as well as memory for the stride prediction values, with a corresponding impact on circuit area and power consumption. Further, if software is used to effect some or all of the pre-fetch process, additional processor cycles are used to execute this software.

Additionally, when a predicted memory access is determined, the cache must be checked to determine whether the predicted memory address is already loaded in the cache. Thus, each repeated predicted access to the cache generally requires two determinations of whether a cache-hit or cache-miss occurs.

It is an object of this invention to provide an efficient cache-prefetch combination. It is a further object of this invention to provide a cache-prefetch combination that does not require a substantial amount of circuitry or software programming. It is a further object of this invention to provide a cache-prefetch combination that is compatible with existing cache or prefetch architectures.

These objects, and others, are achieved by associating a prefetch bit to each cache block, and managing cache-prefetch operations based on the state of this bit. Further efficiencies are gained by allowing each application to identify memory areas within which regularly repeating memory accesses are likely, such as frame memory in a video application. For each of these memory areas, the application also identifies a likely stride value, such as the line length of the data in the frame memory. Pre-fetching is limited to the identified areas, and the prefetch bit is used to identify blocks from these areas and to limit repeated cache hit/miss determinations.

The invention is explained in further detail, and by way of example, with reference to the accompanying drawings wherein:

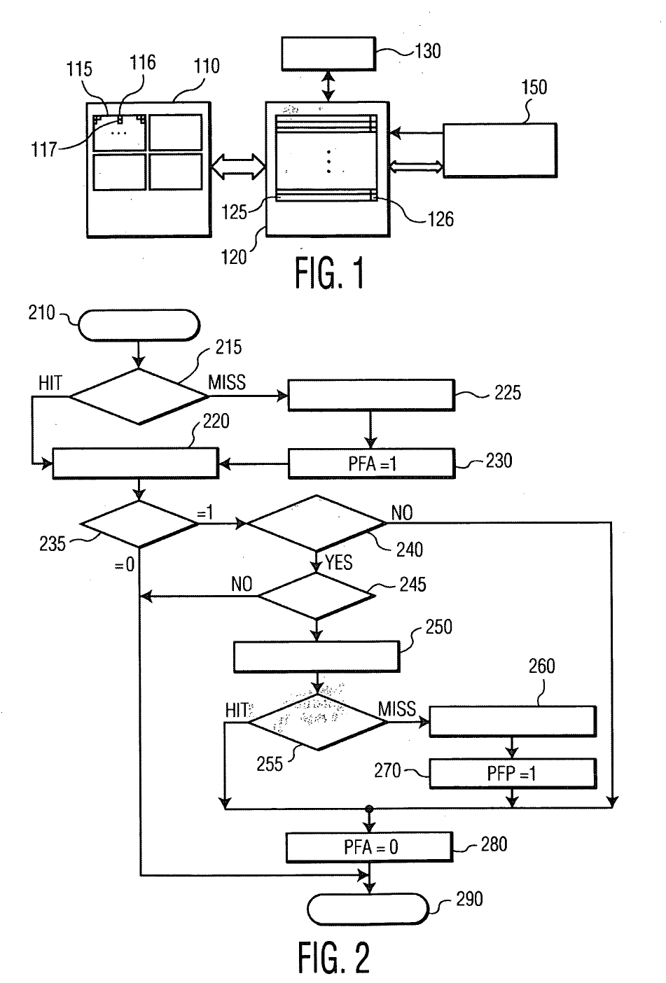

FIG. 1 illustrates an example block diagram of a processing system in accordance with this invention.

FIG. 2 illustrates an example flow diagram of a prefetch controller in accordance with this invention.

Throughout the drawings, the same reference numeral refers to the same element, or an element that performs substantially the same function. The drawings are included for illustrative purposes and are not intended to limit the scope of the invention.

FIG. 1 illustrates an example block diagram of a processing system in accordance with this invention. The processing system includes a processor 150 and a cache 120 that is configured to send and receive data to and from an external memory 110, and to transfer at least some of the data to the processor 150, in response to memory access requests from the processor 150.

A prefetch controller 130 is also included in the processing system of this invention, and may be included within the cache 120 or embodied as a separate module that is coupled to the cache 120, as illustrated in FIG. 1.

In accordance with one aspect of this invention, each block or line 125 of the cache memory 120 includes a prefetch parameter 126 that is used by the controller 130 to determine whether to prefetch other data corresponding to the block 125. In a preferred embodiment, the prefetch parameter 126 is a single binary digit (bit), although a multi-bit parameter may also be used to define various combinations of prefetch options, or different prefetch priorities. A particular use of the parameter 126 by the controller 130 is presented in the flow diagram of FIG. 2, but this invention is not limited to the method illustrated in FIG. 2.

This invention is premised on the observation that the location of the data being accessed can serve as an indication of whether regularly repeating (i.e., predictable) accesses to the memory will occur. In general, the prefetch parameter 126 is used to provide an indication to the controller 130 whether the processor 150 is likely to access prefetched data, based on the data that is located in the block 125 in the cache 120. In a multi-bit embodiment of the parameter 126, the value of the parameter may correspond to a quantitative estimate of the likelihood; in a single-bit embodiment, the value of the parameter corresponds to a simple likely/unlikely, or likely/unknown determination. As noted above, in contrast to conventional stride prediction tables, the likelihood of regularly repeating accesses to the memory is base block of memory that is being accessed, rather than the section of program code that is being executed.

The parameter 126 can also be used to identify blocks for which a prefetch has already been performed, thereby obviating the need to perform multiple cache hit/miss determinations as data items within each block are accessed.

In accordance with another aspect of this invention, an application program can facilitate the determination of whether a block 125 of data in the cache is likely to warrant a prefetch of other data by identifying areas 115 of the memory 110 wherein predictable accesses are likely to occur, based on the principles disclosed in U.S. Patent Application Publication US 2003/0208660, “MEMORY REGION BASED DATA PRE-FETCHING”, filed 1 May 2002 for Jan-Willem van de Waerdt, and incorporated by reference herein. For example, in a video processing application, the application program can identify the area of memory 110 that is used for frame buffering as an area 115 that is suitable for prefetching. Using conventional techniques the application program stores the bounds of each of these prefetching areas 115 in predefined registers or memory locations, and the prefetch controller 130 compares requested memory addresses to these bounds to determine whether the requested memory address is within a prefetching area 115.

In an example embodiment, when the processor 150 that is executing an application first accesses data within a defined area 115, a prefetch is executed. Each block 125 that is subsequently transferred from the area 115 to the cache 120 is identified as a block for which prefetching is warranted, using the parameter 126. As each identified block 125 is accessed, a prefetch of its corresponding prefetch block is performed.

In accordance with a further aspect of this invention, the application program also facilitates the determination of the prefetch stride value. In a typical embodiment, the application program provides the prefetch stride value directly, by storing the stride associated with each prefetching area 115 in a predefined register or memory location. For example, in a video application, wherein adjacent vertical picture elements (pixels) are commonly accessed, and the data in the memory is stored as contiguous horizontal lines of pixels, the application program can store the horizontal line length as the prefetch stride value. If the data in the memory is stored as rectangular tiles, the application program can store the tile size as the prefetch stride value.

Alternatively, the areas 115 of the memory that exhibit predictable memory accesses and/or the stride value associated with each area 115 can be determined heuristically, as the application program is run, using prediction techniques that are common in the art, but modified to be memory-location dependent, rather than program-code dependent.

FIG. 2 illustrates an example flow diagram of a prefetch controller in accordance with this invention, as may be used by the prefetch controller 130 of FIG. 1. At 210, a memory request for a data item located at address A is received. At 215, a cache hit/miss determination is made. If a cache-hit is determined, indicating that the requested data item is located in the cache, the corresponding data item is returned, at 220, thereby allowing the processor 150 of FIG. 1 to continue its operations while the prefetch controller determines whether to prefetch data from the external memory 110.

In accordance with one of the aspects of this invention, the prefetch controller checks to determine whether an access to the requested address A is likely to be followed by a request for data at a prefetch memory location related to address A, at 235. As noted above, the prefetch parameter 126 associated with the block 125 that corresponds to the address A provides an indication of this likelihood. In a preferred embodiment, the prefetch parameter 126 is a binary digit, wherein a “0” indicates that a prefetch is unlikely to be effective, and a “1” indicates that a prefetch is likely to be effective, or that the likelihood is unknown, and should be assumed to be likely until evidence is gathered to determine that a prefetch is unlikely to be effective.

If, at 215, a cache-miss is determined, a block of data corresponding to the address A is retrieved from the external memory, at 225, and the prefetch parameter corresponding to this cache block is set, at 230, to indicate that a check for prefetching should be performed for this block. At 220, the data item corresponding to address A is extracted from the cache block and returned to the processor, thereby allowing the processor 150 of FIG. 1 to continue its operations while the prefetch controller determines, at 235, whether to prefetch data from the external memory 110.

One of ordinary skill in the art will recognize that blocks 215-235, with the exception of block 230, correspond to the operation of a conventional cache controller, and are presented herein for completeness. If a conventional cache controller is used, the prefetch controller 130 can be configured to use the hit/miss output of the cache 120 to selectively execute block 230 when a miss is reported, and then continue to block 235.

If, at 235, the prefetch parameter indicates that a prefetch is likely to be effective, the prefetch control process branches to decision block 240; otherwise, if the prefetch parameter indicates that a prefetch is not likely to be effective, the controller merely returns, at 290, to await another memory request from the processor.

At 240, the controller determines whether a prefetch address corresponding to address A is available. As noted above, in a preferred embodiment of this invention, the application program is configured to identify areas of the external memory wherein prefetching is likely to be effective. Alternatively, the prior memory access activities are assessed to identify/predict such areas, using techniques similar to conventional stride prediction analysis. If address A is determined not to have associated prefetch data, the process continues at 280, discussed below.

If, at 240, address A is determined to have associated prefetch data, the availability of prefetch resources is checked, at 245. If, at 245, a prefetch cannot be executed at this time, the process merely returns, at 290 to await another memory request and a repeat of the above process.

If, at 245, prefetch resources are currently available, the address P of the prefetch data is determined, at 250, preferably by adding the stride value that is associated with the defined prefetching area within which A is located. Alternatively, the aforementioned stride prediction analysis techniques can be used to estimate a stride value. Other conventional techniques for determining a prefetch address P corresponding to address A may also be used if the preferred technique of allowing the application program to define the stride value is not used.

At 255, the cache is assessed to determine whether the prefetch address P is already contained in the cache (a cache-hit). If the address is already in the cache, a prefetch is not necessary, and the process continues at 280, discussed below. Otherwise, at 260, a block of prefetch data corresponding to prefetch address P is retrieved from memory and stored in the cache. At 270, the prefetch parameter (126 of FIG. 1) associated with the cache block containing address P is set to indicate that a prefetch is likely to be effective when address P is accessed by a memory request from the processor.

At 280, the prefetch parameter associated with the cache block that corresponds to the requested memory address A is reset, to indicate that a prefetch is not likely to be effective when a data item from memory address A, or any memory address within the cache block that corresponds to memory address A, is requested by the processor. Note that the reason that a prefetch is not likely to be effective is either because address A has been determined not to have associated address for prefetching (via 240), or because A's associated prefetch address P has already been loaded into the cache (via 255, or 255-260). Thus, once either of these determinations are made, further prefetching overhead is avoided for all of the addresses within the cache block that corresponds to address A.

At 290, the process returns, to await another request for memory access by the processor.

The foregoing merely illustrates the principles of the invention. It will thus be appreciated that those skilled in the art will be able to devise various arrangements which, although not explicitly described or shown herein, embody the principles of the invention and are thus within its spirit and scope. For example, FIG. 1 illustrates an embodiment wherein the prefetch parameter 126 is stored within the cache 120. One of ordinary skill in the art will recognize that the prefetch controller 130 could be configured to contain these prefetch parameters, thereby avoiding having to redesign a conventional cache structure. In like manner, as an alternative to identifying bounds of regions 115 for identifying memory areas that are likely to be accessed in a predictive manner, a table of bits can be used to identify such areas, indexed, for example, by the higher order bits of the memory address. In like manner, the conventional cache tag (which is often the higher order bits of the memory address) can be used to index a table that contains both the bit that identifies an area that is likely to accessed in a predictive manner, as well as the prefetch parameter bit that indicates whether a prefetch is likely to be effective for that block. These and other system configuration and optimization features will be evident to one of ordinary skill in the art in view of this disclosure, and are included within the scope of the following claims.

In interpreting these claims, it should be, understood that: a) the word “comprising” does not exclude the presence of other elements or acts than those listed in a given claim; b) the word “a” or “an” preceding an element does not exclude the presence of a plurality of such elements; c) any reference signs in the claims do not limit their scope; d) several “means” may be represented by the same item or hardware or software implemented structure or function; e) each of the disclosed elements may be comprised of hardware portions (e.g., including discrete and integrated electronic circuitry), software portions (e.g., computer programming), and any combination thereof; f) hardware portions may be comprised of one or both of analog and digital portions; g) any of the disclosed devices or portions thereof may be combined together or separated into further portions unless specifically stated otherwise; h) no specific sequence of acts is intended to be required unless specifically indicated; and i) the term “plurality of” an element includes two or more of the claimed element, and does not imply any particular range of number of elements; that is, a plurality of elements can be as few as two elements.

1. A processing system comprising: a processor that is configured to receive data from a memory, a cache, operably coupled between the processor and the memory, that is configured to receive data from the memory and transfer the data to the processor, and a prefetch controller, operably coupled to the cache, that is configured to identify prefetch data that is to be transferred from the memory to the cache, based on a state of a prefetch parameter associated with the data that was received from the memory.

2. The processing system of claim 1, further including the memory.

3. The processing system of claim 1, wherein the prefetch parameter is a binary digit that identifies whether the processor is likely to request a data item of the prefetch data.

4. The processing system of claim 3, wherein the state of the prefetch parameter is based on whether the data from the memory is from one or more defined prefetching area of the memory.

5. The processing system of claim 1, wherein identifying the prefetch data is also based on a stride value associated with the data that was received from the memory.

6. The processing system of claim 5, wherein the stride value is associated with a defined prefetching area of the memory.

7. The processing system of claim 5, wherein the stride value is determined based on prior accesses to the data that was received from the memory.

8. A cache system comprising: a cache memory comprising a plurality of cache blocks, a prefetch controller, operably coupled to the cache memory, that is configured to transfer prefetch data to the cache memory from an external memory, based on a prefetch parameter associated with each block of the plurality of cache blocks.

9. The cache system of claim 8, wherein the prefetch parameter is a binary digit that indicates whether a processor that is operably coupled to the cache system is likely to request a data item in the prefetch data.

10. The cache system of claim 8, wherein a state of the prefetch parameter is based on whether the corresponding block is transferred from a defined prefetching area of the external memory.

11. The cache system of claim 10, wherein the cache system identifies the prefetch data based on a stride value associated with the defined prefetching area of the external memory.

12. A method of transferring prefetch data from an external memory to a cache, comprising: receiving a request for a data item from a processor, identifying a cache block of the cache that contains the data item, transferring the prefetch data to the cache based on a state of a prefetch parameter associated with the cache block.

13. The method of claim 12, further including: if the data item is not located within the cache, transferring a block of data from the external memory to the cache block.

14. The method of claim 12, wherein transferring the prefetch data to the cache is further based on whether the block of data is associated with a defined prefetching area of the external memory.

15. The method of claim 12, wherein the state of the prefetch parameter is based on whether the block of data is associated with a defined prefetching area of the external memory.

16. The method of claim 15, further including identifying the prefetch data based on a stride value associated with the defined prefetching areas.

17. The method of claim 12, further including determining a stride value associated with the block of data from the external memory, and identifying the prefetch data based on the stride value.
